(19) United States
(12) Patent Application Publication
(10) Pub. No.: US 2013/0262226 A1
(43) Pub. Date: Oct. 3, 2013

(54) SYSTEMS AND METHODS FOR TARGETED INTERNET MARKETING BASED ON OFFLINE, ONLINE, AND CREDIT-RELATED DATA

(71) Applicant: TRANS UNION LLC, Chicago, IL (US)

(72) Inventors: Craig F. LaChapelle, Bethesda, MD (US); Clifton H. Burns, Geneva, IL (US); Steven M. Chaouki, Chicago, IL (US); Tammy P. Mitchell, Kenilworth, IL (US); Patrick White, Goodyear, AZ (US)

(73) Assignee: Trans Union LLC, Chicago, IL (US)

(21) Appl. No.: 13/841,022

(22) Filed: Mar. 15, 2013

Related U.S. Application Data
(60) Provisional application No. 61/618,747, filed on Mar. 31, 2012.

(51) Int. Cl. G06Q 30/02

(52) U.S. Cl. CPC G06Q 30/0255
USPC 705/14.53

(57) ABSTRACT

Systems and methods are disclosed for matching of offline data with online data by comparing the offline data with online data using credit-related data. The systems and methods receive offline data and online data and retrieve credit-related data with identifying information for targeted individuals. The offline data records and online data records are independently compared to the credit-related data to determine whether the data records correspond to a matching targeted individual. If both an offline data record and an online data record correspond to a matching targeted individual, then a key is generated that links the offline data record and the online data record. The key may be stored in a key database. The key may be utilized for targeted marketing to the matching targeted individual. The matching of offline data and online data may be more accurate and complete.

### CROSS-REFERENCE TO RELATED APPLICATION

This application claims priority to U.S. Provisional Application No. 61/618,747, filed Mar. 31, 2012, which is incorporated herein by reference in its entirety.

### TECHNICAL FIELD

This disclosure generally relates to the internet marketing industry, and more particularly, to systems and methods for matching online data with offline data using credit-related data in order to support targeted internet marketing.

### BACKGROUND

In current Internet marketing systems, users, such as buyers of advertising space, advertising businesses, and other advertisers, directly or indirectly purchase or otherwise obtain the advertising space from distributors, such as advertising networks and publishers, to place or otherwise distribute advertisements to targeted individuals using data gleaned from the online activity of the targeted individuals. Targeted individuals may be, for example, consumers and/or persons employed, affiliated, and/or associated with a business, such as owners, executives, and/or employees of the business. Distributors may own the advertising space and/or represent another entity which owns the advertising space. For example, if a consumer navigates to a travel website and enters parameters for a desired vacation, the parameters can be stored as part of the consumer's browsing data. Further, the distributor can obtain the browsing data and use the browsing data to identify advertisements tailored to the various parameters, and serve the advertisements to the consumer while the consumer navigates through various websites.

There are drawbacks, however, to current targeted marketing platforms. In particular, the users and distributors have limitations in identifying targeted individuals and matching various data to the targeted individuals and/or to aggregated pools with sufficient accuracy. The data related to the targeted individuals may include, for example, consumer-related data and/or business-related data. As a result, the users have a limited view in identifying targeted individuals with credit-, service-, or product-related advertisements and offers, such as, for example, credit card applications, small business loans, vehicle offers, non-financial services offers, offers related to improving business operations, and/or other similar advertisements and offers.

Furthermore, current systems typically match offline data directly to online data to determine exact matches for targeted marketing to targeted individuals. Online data includes data related to activity on the Internet or other telecommunications networks, and can include, for example and without limitation, data associated with web browsing, click-through data, click stream data, cookies, e-mail account information, online registration data, transaction data, and/or similar data. Offline data includes data that is not online data and can include, for example and without limitation, consumer- or business-related data, public records, and/or similar data. Matching offline data directly to online data for targeted marketing purposes can be incomplete or inaccurate, particularly if either or both types of data do not include enough information to successfully match one another. If the matches are incomplete or inaccurate, then the effectiveness of a targeted marketing campaign based on the matching may be reduced or ineffective. For example, the matching may result in a false negative, e.g., certain consumers or business owners may not be targeted when they should have been, or a false positive, e.g., other consumers or business owners may be targeted when they should not have been. When matching results in false negatives or false positives, the advertising space from distributors may be less valuable, and users may waste or inefficiently allocate spending on advertising and marketing.

Therefore, there exists an opportunity for improved systems and methods that can match and link offline data and online data more completely and accurately, in order to, among other things, provide better leads and more effective management of advertising and marketing spending.

### SUMMARY

The invention is intended to solve the above-noted problems by providing systems and methods for matching of offline data with online data using information, such as credit-related data, from a database, such as a credit data database. The systems and methods are designed to, among other things: (1) receive the offline data and the online data; (2) retrieve credit-related data; (3) compare offline data records to the credit-related data to determine whether the offline data records corresponds to a matching targeted individual; (3) compare online data records to the credit-related data to determine whether the online data records corresponds to a matching targeted individual; and (4) if an offline data record and an online data record both correspond to a matching targeted individual, generate a key linking the offline data record and the online data record, and store the key in a key database. This systems and methods utilize the depth and quantity of the various pieces of data, such as names and addresses within the credit files, and the ability of the matching algorithms to manage variations in data to establish a link between the offline data and the online data.

In a particular embodiment, offline data including at least one offline data record and online data including at least one online data record may be received. Credit-related data may be retrieved from a database, such as a credit data database, and may include identifying information for a plurality of targeted individuals. The offline data record may be compared to the credit-related data to determine whether the offline data record corresponds to a matching targeted individual of the plurality of targeted individuals. The online data record may be compared to the credit-related data to determine whether the online data record corresponds to the matching targeted individual. If both the offline data record and the online data record correspond to the matching targeted individual, a key may be generated that links the offline data record and the online data record. The key may be stored in a key database.

In another embodiment, a system may include a processor in communication with a network and a memory in communication with the processor. The memory may include a database, such as a credit data database, and a key database. The memory may also include a matching engine for receiving offline data including at least one offline data record and online data including at least one online data record. The matching engine may retrieve credit-related data from the database, and the credit-related data may include identifying information for a plurality of targeted individuals. The offline record may be compared by the matching engine to the credit-related data to determine whether the offline data record corresponds to a matching targeted individual of the plurality of targeted individuals. The online data record may be compared by the matching engine to the credit-related data to determine whether the online data record corresponds to the matching targeted individual. If both the offline data record and the online data record correspond to the matching targeted individual, the matching engine may generate a key that links the offline data record and the online data record. The key may be stored by the matching engine in a key database.

The systems and methods also include matching a set of data from an offline data source to associated online data, wherein the set of data comprises information on targeted individuals, such as a plurality of consumers and/or a plurality of persons employed, affiliated, and/or associated with a business. The systems and methods further include examining the set of data to generate a matched set of data, and comparing the matched set of data to the associated online data to identify at least a portion of the targeted individuals that meet criteria of the matched set of data for targeted advertising offers. In some embodiments, the targeted advertising offers can be based on criteria specified by users offering the advertisements.

The systems and methods as described herein provide various advantages over existing platforms. For example, by matching offline data to online data (e.g., cookies), users can target criteria-meeting consumers with prescreened or other credit-related offers, such as an invitation to apply (ITA). Further, users can target persons employed, affiliated, and/or associated with a business with offers or advertisements based on the businesses meeting or matching certain business marketing segments. Still further, the offline data can be matched to the online data in a more effective and efficient manner using the techniques as discussed herein. It should be appreciated that other advantages and improvements are envisioned by the embodiments as described herein.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF DRAWINGS

FIG. 1 is a schematic diagram of an exemplary environment and associated functionality in accordance with one or more aspects described herein.

FIG. 2 is a chart of exemplary functionality according to one or more aspects described herein.

FIG. 3 is a chart of exemplary functionality according to one or more aspects described herein.

FIG. 4 is a flow chart of an exemplary method according to one or more aspects described herein.

FIG. 5 is a flow chart of an exemplary method according to one or more aspects described herein.

FIG. 6 is a schematic diagram of an exemplary device capable of supporting and facilitating one or more aspects described herein.

FIG. 7 is a block diagram illustrating a system for matching of offline data and online data with credit-related data.

FIG. 8 is a flow chart of an exemplary method for matching of offline data and online data with credit-related data.

FIG. 9 is a flow chart of an exemplary method for comparing data to credit-related data.

FIG. 10 is a flow chart of another exemplary method for comparing data to credit-related data.

FIG. 11 is a flow chart of another exemplary method according to one or more aspects described herein.

### DETAILED DESCRIPTION OF EXEMPLARY EMBODIMENTS

The description that follows describes, illustrates and exemplifies one or more embodiments in accordance with their principles. This description is not provided to limit the embodiments described herein, but rather to explain and teach the principles of the embodiments in such a way to enable one of ordinary skill in the art to understand these principles and, with that understanding, be able to apply them to practice not only the embodiments described herein, but also other embodiments that may come to mind in accordance with these principles. The scope of the embodiments is/are intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers such as, for example, in cases where such labeling facilitates the didactic purpose of the specification. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the embodiments as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “online data” can refer to data associated with Internet or online activity, such as, for example and without limitation, data associated with web browsing, click-through data, click stream data, cookies, e-mail account information (e.g., e-mail addresses, names, etc.), online registration data (e.g., names, addresses, phone number, etc.), online transaction data, online site usage data (e.g., social networking usage data, etc.), IP addresses, electronic device identifiers (e.g., IMEI, IMSI, UDID, Android ID, phone numbers, etc.), search result data, biometric data, network identifiers, Media Access Control addresses, and/or other similar data. Online data may also include data associated with mobile applications executing on electronic devices, SMS messages, instant messages, and the like. Further, as used herein, the term “offline data” can refer to any data that is associated with non-Internet or non-online activity and that is separate from the online data. For example and without limitation, offline data can be consumer- or business-related data, consumer identifying data, aggregated credit data, credit scores, pre-screen offers, business identifiers, product profits, estimated incomes, actual incomes, consumer behavioral data, wealth data, education data, vehicle ownership data, proprietary data, non-aggregated credit data, public records, and/or similar data.

It should also be noted that the disclosures made in this specification are in accordance with the principles of the embodiments(s), which are intended to be disclosed or interpreted to their broadest extent under the patent laws, and while such disclosure may describe or otherwise cover subject matter that may be regulated by other existing laws or regulations, including, without limitation, the Fair Credit Reporting Act (FCRA) or the Equal Credit Opportunity Act (ECOA), nothing in this disclosure is intended to suggest or imply noncompliance with any such law or regulation by the assignee. It should also be noted that nothing in this disclosure is intended to suggest or imply that aggregated credit data can be used to determine the credit or insurance eligibility of an individual consumer and/or targeted individual.

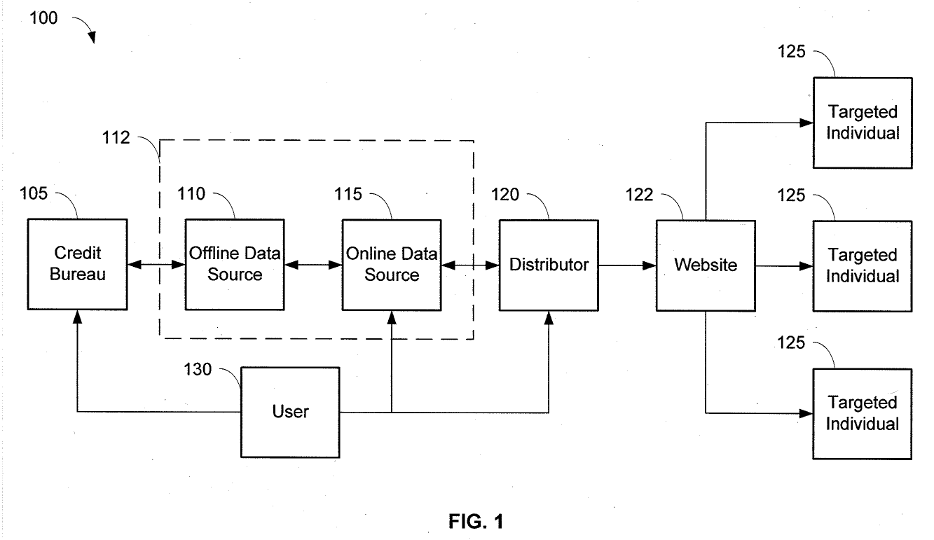

Referring to FIG. 1, an exemplary environment 100 in which the systems and methods can be implemented is illustrated. It should be appreciated that the environment 100 is merely exemplary and can comprise other various combinations of components as discussed herein.

As shown in FIG. 1, the environment 100 includes a credit bureau 105 configured to interface with an offline data source 110 and/or an online data source 115, such as a matching partner or a data mart. In embodiments, the offline data source 110 can interface with the online data source 115 to exchange data, and can be combined into a single processing entity 112. The credit bureau 105 can be any company or entity that collects information or data from various sources and provides information about targeted individuals, such as consumers, to other entities for a variety of uses such as, for example, to assess credit worthiness, determine a loan interest rate, and/or perform other uses. Targeted individuals may be, for example, consumers and/or persons employed, affiliated, and/or associated with a business, such as owners, executives, and/or employees of the business. The information and data can include financial-related information as well as non-financial related and identifying information, such as that found in credit-related data including credit header data, such as, for example, a name, address, telephone number, location information such as ZIP+4 data, and/or other data. Variations in the data include, but are not limited to, nicknames, name reversals, partial names, maiden names and previous addresses. Further, the offline data source 110 can be any company, entity, or component that can aggregate, collect, and store marketing data such as purchasing data, transactional data, and the like. The offline data source 110 can aggregate the data into pools based on demographics (e.g., location, income, etc.) and Internet browsing habits.

The online data source 115 can aggregate anonymous behaviors from websites such as ecommerce sites, and classify the behaviors. According to embodiments, a distributor 120 can purchase the online data from the online data source 115 for the purpose of providing advertisements to targeted individuals 125, such as a set of consumers, via a website 122 to which the set of targeted individuals 125 can browse. The distributor 120 can be any type of data exchange, marketer, ad network, publisher, and/or the like that can use the purchased data to provide advertisements relevant to the targeted individuals 125 via the website 122. The distributor 120 can be any company, entity or system that can provide, auction, or otherwise sell data, such as online data, intent data, and/or the like, to individuals or entities. In embodiments, the exchange or selling of the data can occur on a real-time basis. More particularly, when the targeted individual 125 navigates throughout or browses to various websites 122, the distributor 120 can serve targeted advertisements based on the data purchased from the online data source 115. The targeted advertisements can display on the website 122 to which the targeted individuals 125 are browsing. The website 122 may in some embodiments leverage web tags to cause a web browser to display one or more ads, or otherwise collect data to be provided to the distributor 120.

As shown in FIG. 1, the environment 100 further includes a user 130 that can have relationships with any of the credit bureau 105, the online data source 115, and the distributor 120. The user 130 may be, for example, buyers of advertising space, advertising businesses, and other advertisers. More particularly, the user 130 can have a set of advertisements or offers that the user 130 wants the distributor 120 to provide to the targeted individuals 125. For example, the user 130 can be a bank with prescreen credit card offers that the bank wants an ad network to distribute to targeted individuals.

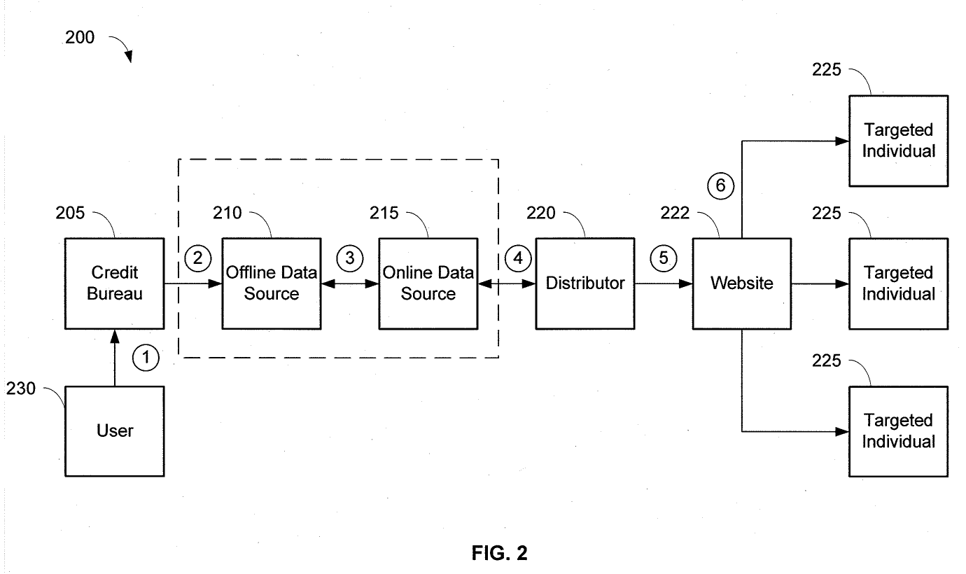

FIG. 2 illustrates an exemplary flow environment 200 according to embodiments as described herein, in one regard. According to embodiments, the flow environment 200 illustrates techniques for leveraging data to assemble targeted advertisements. More particularly, the targeted advertisements can be credit-related prescreened offers, invitations to apply, and/or other types of offers or advertisements that are intended for placement or distribution to targeted individuals. Targeted individuals may be, for example, consumers and/or persons employed, affiliated, and/or associated with a business, such as owners, executives, and/or employees of the business.

Referring to FIG. 2, a user 230 can request (1) a credit bureau 205 to create a custom data feed based on a set of criteria and/or an input list provided by the user 230. The user 230 may be, for example, buyers of advertising space, advertising businesses, and other advertisers. For example, the criteria can specify a set of targeted individuals, such as consumers, with a credit score of at least 740. In some embodiments, the user 230 can request an online data source 215 for the custom data feed, and the online data source 215 can interface with the credit bureau 205 to create the custom data feed. The credit bureau 205 can access a set of credit data related to a plurality of targeted individuals, such as, various credit attributes or other offline data, and can generate the custom data feed by matching the targeted individuals that fulfill the criteria. In embodiments, the credit bureau 205 can generate the custom data feed by using credit-related data, such as credit header data, to match the offline data. Continuing with the example, the credit bureau 205 can examine the set of credit data to identify the targeted individuals having a credit score of at least 740. In embodiments, the custom data feed can comprise credit header data including information such as name, addresses, phone numbers, and/or other information.

After the credit bureau 205 generates the custom data feed, the credit bureau 205 can provide (2) the custom data feed to an offline data source 210. In some embodiments, the credit bureau 205 can depersonalize the custom data feed according various depersonalizing techniques. For example, the targeted individuals of the custom data feed can be grouped or categorized into locations according to ZIP+4 data, without identifying information. In this way, an exemplary custom data set can comprise geographic locations or areas of qualifying targeted individuals without the names of the targeted individuals.

The offline data source 210 can interface with the online data source 215 (3) to share or exchange the custom data feed. Further, the online data source 215 can store and/or access online data associated with Internet browsing activities of a plurality of targeted individuals 225, such as consumers. In some cases, the online data can include cookie data that is collected when a targeted individual accesses a webpage. For example, if a consumer visits a travel site and searches for flights to Europe, the online data can be updated with preferences of the consumer (e.g., flight date, destination, etc.), and the online data source 215 can store the preferences in a data file associated with the targeted individual 225.

When the offline data source 210 interfaces with the online data source 215, the custom data feed received from the credit bureau 205 is matched to the online data of the plurality of targeted individuals 225. More particularly, the preference/cookie data of the plurality of targeted individuals 225 is matched to the custom data feed that identifies targeted individuals who quality for or meet the criteria of the user 230. Further, the online data source 215 can refine or update the online data such that the refined online data includes one or more of the targeted individuals 225 who quality for or meet the criteria of the user 230. In embodiments, the online data source 215 can depersonalize the refined online data such that the refined online data does not contain identifying information of targeted individuals.

In cases in which the credit bureau 205 depersonalizes the custom data feed, such as via ZIP+4 rules or techniques, the online data source 215 can match the depersonalized custom data feed to the online data of the plurality of targeted individuals 225 to geographically locate one or more of the plurality of targeted individuals 225 who qualify for or meet the criteria of the user 230. More particularly, the online data source 215 can refine or update the online data such that the refined online data includes geographical information (e.g., ZIP+4 data) of one or more of the targeted individuals 225 who quality for or meet the criteria of the user 230.

According to embodiments, the online data source 215 can provide (4) the refined online data to a distributor 220. The distributor 220 can be an ad network or other entity with a relationship with the user 230 to deliver or provide advertisements of the user 230. Continuing with the above example, the user 230, such as a bank, can provide the distributor 220 with requirements and/or parameters for various credit-related offers or advertisements. In some cases, the advertisements can relate to prescreened or preapproved offers. In other cases, such as when the custom data feed is depersonalized, the advertisements can be offers that target targeted individuals in various ZIP code regions where the average resident meets certain criteria such as risk score, income level, and/or the like. Upon the distributor 220 purchasing a portion of the refined or matched online data from the online data source 215, the distributor 220 can have information on one or more of the targeted individuals 225 who may be interested in applying for the credit card, who would likely qualify for the credit card, or both. Continuing with the above example, the invitation to apply for the credit card can be tailored to targeted individuals with a credit score of at least 740. In particular, the credit card can offer a large percentage cash back on various purchases, concierge services, and/or other perks that may appeal to the target demographic.

The distributor 220 can provide (5) the advertisements to a website 222 to ultimately serve or provide (6) to the one or more of the targeted individuals 225. More particularly, the website 222 can use the refined or matched online data, including cookie data, to provide the advertisements when the targeted individual is navigating or browsing to the website 222. In embodiments, the website 222 can be a specific website that has a partnership or relationship with the distributor 220. Continuing with the above example, the distributor 220 can purchase online data associated with a set of targeted individuals 225 that meet the user's 230 credit criteria. When one of the set of targeted individuals 225 navigates to the website 222, the distributor 220 can provide, via the website 222, the targeted individual 225 with, for example, an advertisement indicating that the targeted individual 225 has been preapproved or prescreened for a credit card offer. The targeted individual 225 can select the advertisement and be directed to a website of the user 230 that allows the targeted individual 225 to enter information to receive the credit card. In cases in which the custom data feed is depersonalized, the advertisement can be an invitation to apply for a credit-related offer, such as a mortgage, a credit card, a home equity loan, and/or the like. Similar to the prescreened offer, the targeted individual 225 can select the advertisement and be directed to a website of the user 230 that allows the targeted individual 225 to apply for the offer.

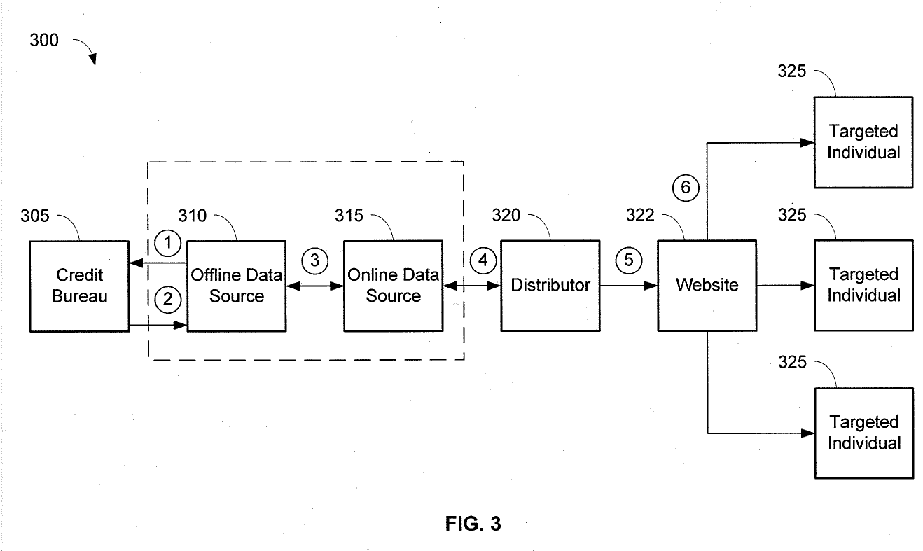

FIG. 3 illustrates an exemplary flow environment 300 according to embodiments as described herein, in one regard. According to embodiments, the flow environment 300 illustrates techniques for leveraging data to assemble targeted advertisements for targeted individuals, such as consumers and/or persons employed, affiliated, and/or associated with businesses, including owners, executives, and/or employees of the businesses. More particularly, the targeted advertisements can be credit-related invitations to apply and/or other types of business-related offers or advertisements.

Referring to FIG. 3, an offline data source 310 can provide (1), to a credit bureau 305, a set of data files including information on a plurality of targeted individuals. In some embodiments, a user such as, for example, a bank, can request the credit bureau 305 to compile a custom data feed based on a set of criteria, and the credit bureau 305 can request the set of data files from the offline data source 310. The user may be, for example, buyers of advertising space, advertising businesses, and other advertisers. The data files can include names, addresses, and other information about the plurality of targeted individuals. After the credit bureau 305 receives the data files, the credit bureau 305 can process the data files to align or match the data with available business data, such as small business data. In embodiments, the business data can include segments that indicate data such as a code identifying a type of business, as well as other data indicating business location, affiliates, number of employees, years in business, legal entity information, annual revenue, industry description, and/or other data.

The credit bureau 305 can generate a custom data feed that matches business owners, executives, and/or other targeted individuals included in the received data files to the business data. More particularly, the custom data feed can include identifications of targeted individuals and/or households, as well as business marketing segments (e.g., sales revenue, number of employees, etc.) that correspond to each of the targeted individuals and/or households. In embodiments, the custom data feed can be generated using credit-related data, such as credit header data, including information such as name, addresses, phone numbers, and/or other information. Further, the credit bureau 305 can depersonalize the custom data feed according to ZIP+4 rules or other depersonalizing techniques. More particularly, the targeted individuals of the custom data feed can be grouped or categorized into locations according to ZIP+4 data, without identifying information. For example, an exemplary custom data set can comprise geographic locations or areas of qualifying targeted individuals without the names of the targeted individuals.

After the credit bureau 305 generates the custom data feed that matches targeted individuals to business marketing segments, the credit bureau 305 can provide (2) the custom data feed to the offline data source 310. The offline data source 310 can interface with an online data source 315 (3) to share or exchange the custom data feed. More particularly, the online data source 315 can store and/or access online data associated with Internet browsing activities of a plurality of targeted individuals 325. For example, the targeted individuals 325 can be small business owners or other individuals associated with businesses. In some cases, the online data can include cookie data that is collected when a targeted individual accesses a webpage, as discussed herein. More particularly, the online data source 315 can store the preferences identified from a browsing history in a data file associated with the targeted individual 325.

When the offline data source 310 interfaces with the online data source 315, the custom data feed received from the credit bureau 305 is matched to the online data of the plurality of targeted individuals 325. More particularly, the preference/cookie data of the plurality of targeted individuals 325 is matched to the custom data feed to identify targeted individuals who may be interested in applying for an offer or may otherwise be interested in other products or services. For example, the offer can be an invitation to apply for a small business loan. For further example, the offer can be for a service/sales agreement with a business supply company. In some cases, the custom data feed can be matched to the online data of the plurality of targeted individuals 325 based on a set of criteria from a user such as, for example, a bank, a supply company, or other entity.

In embodiments, the online data source 315 can match the custom data feed to the online data of the plurality of targeted individuals 325 to generate refined online data. In some cases, the refined online data can be used to geographically segment one or more of the plurality of targeted individuals 325. More particularly, the online data source 315 can refine or update the online data such that the refined online data includes geographical information (e.g., ZIP+4 data) of targeted individuals 325 who can be targeted for advertisements. In embodiments, the online data source 315 can depersonalize the refined online data such that the refined online data does not contain identifying information of the targeted individuals 325.

According to embodiments, the online data source 315 can provide (4) the refined online data to a distributor 320. The distributor 320 can be an ad network or other entity with a relationship with a user to deliver or provide advertisements. For example, a user (e.g., a bank) can provide the distributor 320 with an advertisement to apply for a small business loan. It should be appreciated that other advertisements relating to invitations to apply and other credit-based advertisements are envisioned. In embodiments, the advertisements can relate to other business-related products and/or services. Upon the distributor 320 purchasing a portion of the refined online data from the online data source 315, the distributor 320 has information on one or more of the targeted individuals 325 who may be interested in what the advertisement is advertising. For example, the advertisement can be for a small business loan, and the refined browser data can contain data about a portion of the targeted individuals 325 who oversee business revenue below a certain threshold.

The distributor 320 can serve or otherwise provide (5) the advertisements to a website 322 to ultimately serve or provide (6) to the one or more of the targeted individuals 325. More particularly, the website 322 can use the refined online data, including cookie data, to provide the advertisements when the applicable targeted individual 325 is navigating or browsing to the website 322. In embodiments, the website 322 can be a specific website that has a partnership or relationship with the distributor 320. For example, the distributor 320 can purchase online data associated with a set of targeted individuals 325 that meet a certain market segment criteria. When one of the set of targeted individuals 325 navigates to the website 322, the distributor 320 can provide the targeted individual 325 with, for example, an advertisement that offers a discount for printing business cards. The targeted individual 325 can select the advertisement and be directed to a website associated with the advertisement that allows the targeted individual 325 to enter information related to the offer.

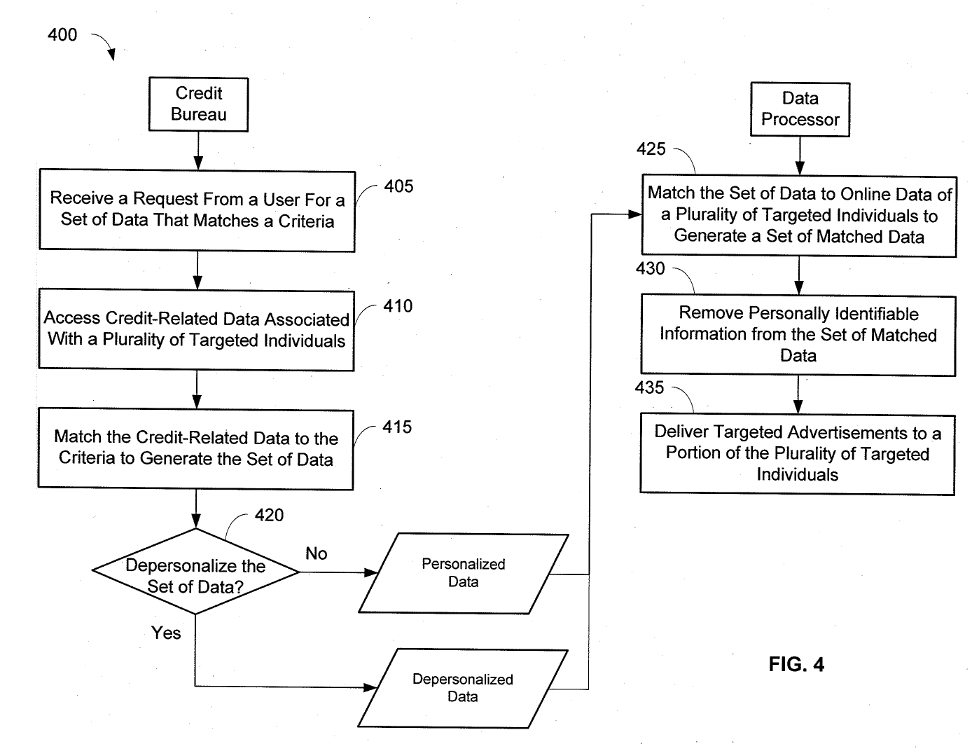

FIG. 4 is a flowchart of a method 400 for targeted marketing to targeted individuals using online data. In particular, the method 400 relates to matching criteria to credit-related data for a plurality of targeted individuals. The method 400 can result in a high matching confidence for efficiently targeting targeted individuals with various advertisements. Targeted individuals may be, for example, consumers and/or persons employed, affiliated, and/or associated with a business, such as owners, executives, and/or employees of the business.

The method begins with the credit bureau receiving 405 a request from a user for a set of data that matches a criteria. The user may be, for example, buyers of advertising space, advertising businesses, and other advertisers. In particular, the criteria can specify credit-related requirements for targeted individuals that the user would like to target. The credit bureau accesses 410 credit-related data associated with a plurality of targeted individuals and matches 415 the credit-related data to the criteria to generate the set of data. More particularly, the credit-related data can be offline data, as discussed herein, and the set of data can include a listing of targeted individuals who qualify for the criteria, and can be generated using credit-related data, such as credit header data, associated with the qualifying targeted individuals. The credit bureau determines 420 whether to depersonalize the set of data. In embodiments, the credit bureau can depersonalize the data if the intended advertisements are invitations to apply or other similar offers. In depersonalizing the data, the credit bureau can append geographic information, such as ZIP+4 data, that can be used to segment groups of targeted individuals based on location. Further, the credit bureau can leave the data as-is if, for example, the intended advertisements are prescreened or preapproved offers.

If the credit bureau does not depersonalize the data (“NO”), the credit bureau can send the personalized data to a data processor entity. In embodiments, the data processor entity can include an offline data source or online data source, such as a matching partner, as discussed herein. If the credit bureau does depersonalize the data (“YES”), the credit bureau can send the depersonalized data to the data processor. The data processor matches 425 the appropriate set of data to online data of a plurality of targeted individuals to generate a set of matched data. For example, the online data can include cookie data associated with a browsing history for a plurality of targeted individuals, and the set of matched data can include consumer credit data appended or matched to the online data. In cases in which the data processor receives depersonalized data, the set of matched data can geographically locate one or more targeted individuals who meet the specified criteria of the user (from 405). The data processor further removes 430 personally identifiable information from the set of matched data such that the set of matched data does not contain identifying information of the targeted individuals. The data processor delivers 435 targeted advertisements to a portion of the plurality of targeted individuals based on the set of matched data via a distributor and a website. For example, the distributor can be an ad network that serves advertisements of the user (from 405) to a plurality of targeted individuals according to the set of matched data. In some cases, the data processor can sell or otherwise provide the set of matched data to the distributor.

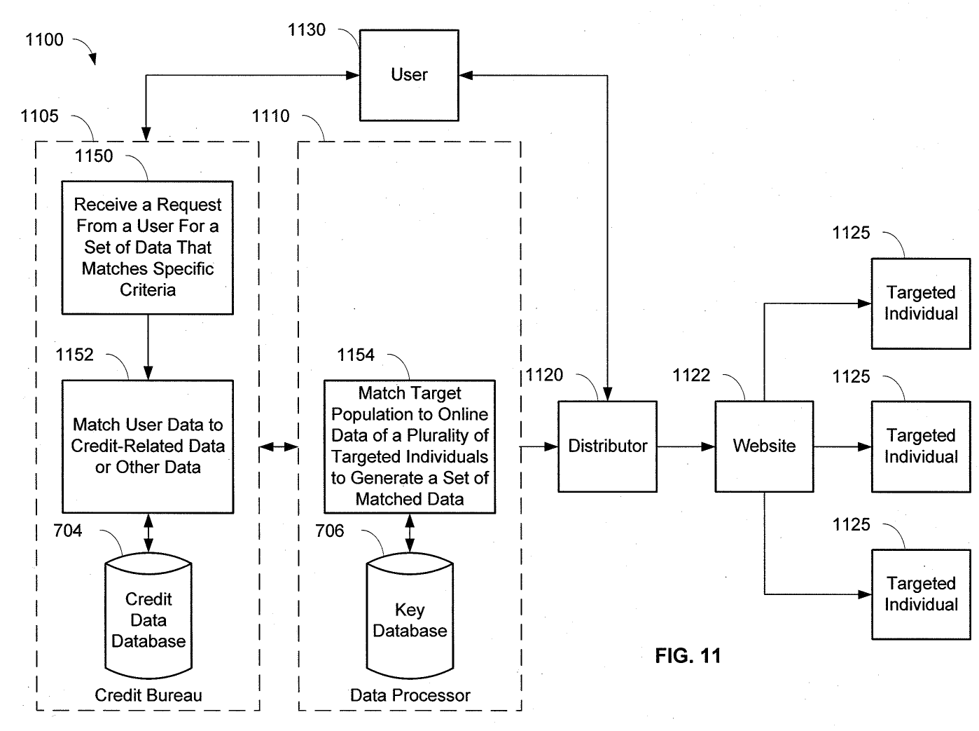

Referring to FIG. 11, a flowchart of a method 1100 for targeted marketing to targeted individuals using online data is shown. In particular, the method 1100 relates to matching specific criteria to credit-related data for a plurality of targeted individuals. The method 1100 can result in a high matching confidence for efficiently targeting targeted individuals with various advertisements. As seen in FIG. 11, a credit bureau 1105 can receive 1150 a request from a user 1130 for a set of data that matches specific criteria. The user may be, for example, buyers of advertising space, advertising businesses, and other advertisers. The user 1130 can have a set of advertisements or offers that the user 1130 wants a distributor 1120 to provide to the targeted individuals 1125. In particular, the criteria can specify credit-related requirements for targeted individuals that the user 1130 would like to target. The credit bureau 1105 can match 1152 offline data, such as data from the user 1130, to credit-related data or other data. The credit-related data may be accessed from a database, such as a credit data database 704 of the credit bureau 1105.

The matched user data can be sent to a data processor 1110, which can match 1154 a target population to the online data of the plurality of targeted individuals to generate a set of matched data. Keys that link particular offline data records and particular online data records can be generated based on the set of matched data, and the keys can be stored in a key database 706. Based on the set of matched data, the distributor 1120 can provide advertisements to targeted individuals 1125 via a website 122 to which the targeted individuals can browse. More particularly, when the targeted individual 1125 navigates throughout or browses to various websites 1122, the distributor 1120 can serve targeted advertisements based on the key and/or the set of matched data.

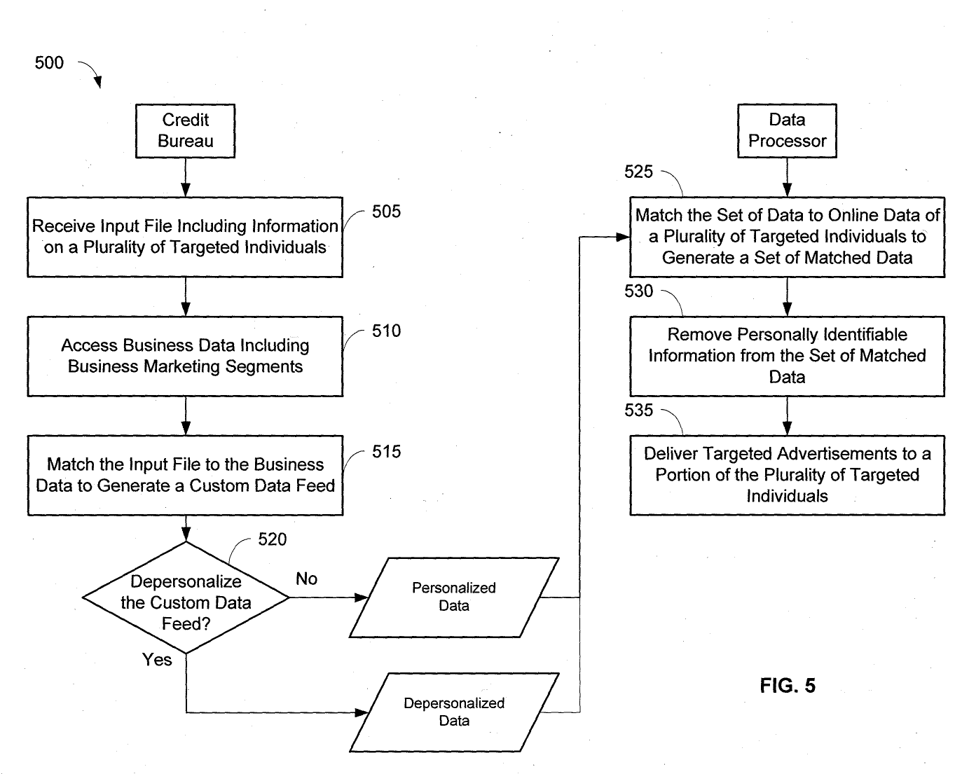

FIG. 5 is a flowchart of a method 500 for targeted marketing to targeted individuals, such as persons employed, affiliated, and/or associated with a business, using online data. In particular, the method 500 relates to a credit bureau matching data to business marketing segments. Targeted individuals may be, for example, consumers and/or persons employed, affiliated, and/or associated with a business, such as owners, executives, and/or employees of the business.

The method begins with the credit bureau receiving 505 an input file including information on a plurality of targeted individuals. For example, the input file can be offline data including names and addresses of the plurality of targeted individuals. The credit bureau accesses 510 business data that includes business marketing segments. More particularly, the business marketing segments can relate to business location, affiliates, number of employees, years in business, legal entity information, annual revenue, industry description, and/or other data. The credit bureau matches 515 the input file to the business data to generate a custom data feed that matches targeted individuals, such as business owners, executives, and/or employees, included in the input file to the business data. The credit bureau determines 520 whether to depersonalize the set of data. In embodiments, the credit bureau can depersonalize the data if the intended advertisements are invitations to apply or other similar offers. In depersonalizing the data, the credit bureau can append geographic information, such as ZIP+4 data, that can be used to segment groups of targeted individuals based on location. Further, the credit bureau can leave the data as-is if, for example, the intended advertisements are prescreened.

If the credit bureau does not aggregate and depersonalize the data (“NO”), the credit bureau can send the personalized data to a data processor entity. In embodiments, the data processor entity can include an offline data source or an online data source, such as a matching partner, as discussed herein. If the credit bureau does depersonalize the data (“YES”), the credit bureau can send the depersonalized data to the data processor. The data processor matches 525 the appropriate set of data to online data of a plurality of targeted individuals to generate a set of matched data. For example, the online data can include cookie data associated with a plurality of targeted individuals, and the set of matched data can include data that has the business segments matched to the browsing histories of targeted individuals. In cases where the data processor receives depersonalized data, the set of matched data can geographically locate one or more targeted individuals who meet the target business segments. The data processor further removes 530 personally identifiable information from the set of matched data such that the set of matched data does not contain identifying information of the targeted individuals. The data processor delivers 535 targeted advertisements to a portion of the plurality of targeted individuals based on the set of matched data via a distributor and a website. For example, the distributor can be an ad network that serves advertisements to the targeted individuals according to the set of matched data. In some cases, the data processor can sell or otherwise provide the set of matched data to the distributor.

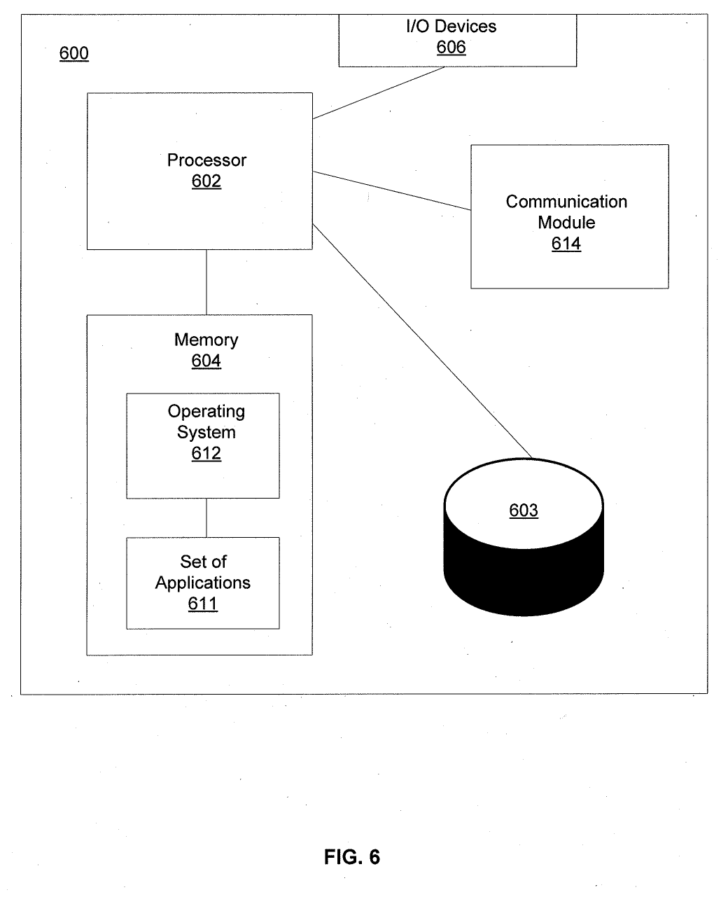

FIG. 6 is a block diagram of a computing device 600 housing executable software used to facilitate the systems and methods as described herein. One or more instances of the computing device 600 may be utilized to implement any, some, or all of the entities in the environment 100, including the credit bureau 105, offline data source 110, online data source 115, and/or distributor 120. One or more instances of the computing device 600 may be utilized to implement any, some, or all of the entities in the matching system 700, described below, including the matching engine 702. The computing device 600 includes a memory 604 that can include a computer readable medium for implementing the systems and methods as described herein, and for implementing particular embodiments. The computing device 600 also contains executable software, some of which may or may not be unique to the systems and methods.

In some embodiments, the systems and methods can be implemented in software, as an executable program, and can be executed by one or more special, or general purpose digital computer(s), such as a mainframe computer, a personal computer (desktop, laptop or otherwise), personal digital assistant, or other handheld computing device. Therefore, the computing device 600 may be representative of any computer in which the systems and methods reside or partially reside.

Generally, in terms of hardware architecture as shown in FIG. 6, the computing device 600 includes a processor 602, the memory 604, and one or more input and/or output (I/O) devices 606 (or peripherals) that are communicatively coupled via an interface such as one or more buses or other wired or wireless connections, as is known in the art. The processor 602 can be a hardware device for executing software, particularly software stored in the memory 604. Further, the processor 602 can interface with a database 603 that can store various amounts and types of data. For example, the database can store credit-related data and other types of data. The processor 602 can be any custom made or commercially available processor, such as, for example, a Core series or vPro processor made by Intel Corporation, or a Phenom, Athlon or Sempron processor made by Advanced Micro Devices, Inc. In the case where the computing device 600 is a server, the processor 602 may be, for example, a Xeon or Itanium processor from Intel, or an Opteron-series processor from Advanced Micro Devices, Inc. The processor 602 may also represent multiple parallel or distributed processors working in unison.

The memory 604 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). Further, the memory 604 may incorporate electronic, magnetic, optical, and/or other types of storage media and can have a distributed architecture where various components are situated remote from one another, but are still accessed by the processor 602. These other components may reside on devices located elsewhere on a network or in a cloud arrangement.

The software in the memory 604 may include one or more separate programs or applications 611. The separate applications 611 comprise ordered listings of executable instructions for implementing logical functions, such as functions relating to matching data, as discussed herein. In the example of FIG. 6, the software in the memory 604 may include a suitable operating system (O/S) 612. Examples of some operating systems 612 are Windows operating systems available from Microsoft Corporation, Mac OS X available from Apple Computer, Inc., a Unix operating system from AT&T, or a Unix-derivative such as BSD or Linux. The type of the operating system 612 will depend on the type of the computing device 600. For example, if the computing device 600 is a PDA or handheld computer, the operating system 612 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. The operating system 612 can control the execution of other computer programs, and can provide scheduling, input-output control, file and data management, memory management, and communication control and related services.

If the computing device 600 is an IBM PC compatible computer or the like, the software in the memory 604 may further include a basic input output system (BIOS). The BIOS is a set of essential software routines that initialize and test hardware at startup, start the operating system 612, and support the transfer of data among the hardware devices. The BIOS is stored in ROM so that the BIOS can be executed when the computing device 600 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components and entities as discussed herein may also be written in a proprietary language developed to interact with these known languages.

The I/O device(s) 606 may include input devices such as a keyboard, a mouse, a scanner, a microphone, a touch screen, a bar code reader, or an infra-red reader. It may also include output devices such as a printer, a video display, an audio speaker or headphone port or a projector. The I/O device(s) 206 may also comprise devices that communicate with inputs or outputs, such as a short-range transceiver (RFID, Bluetooth, etc.), a telephonic interface, a cellular communication port, a router, or other types of network communication equipment. The I/O devices 606 may be internal to the computing device 600, or may be external and connected wirelessly or via connection cable, such as through a universal serial bus port.

When the computing device 600 is in operation, the processor 602 is configured to execute software stored within the memory 604, to communicate data to and from the memory 604, and to generally control operations of the computing device 600 pursuant to the software. The operating system 612, in whole or in part, may be read by the processor 602, buffered within the processor 602, and then executed.

In the context of this document, a “computer-readable medium” may be any means that can store, communicate, propagate, or transport data objects for use by or in connection with the systems and methods as described herein. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The systems and methods can be embodied in any type of computer-readable medium for use by or in connection with an instruction execution system or apparatus, such as a computer.

For purposes of connecting to other computing devices, the computing device 600 is equipped with network communication equipment and circuitry, including a communication module 614. In embodiments, the network communication equipment includes a network card such as an Ethernet card, or a wireless connection card. In a preferred network environment, each of the plurality of computing devices 600 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 600 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

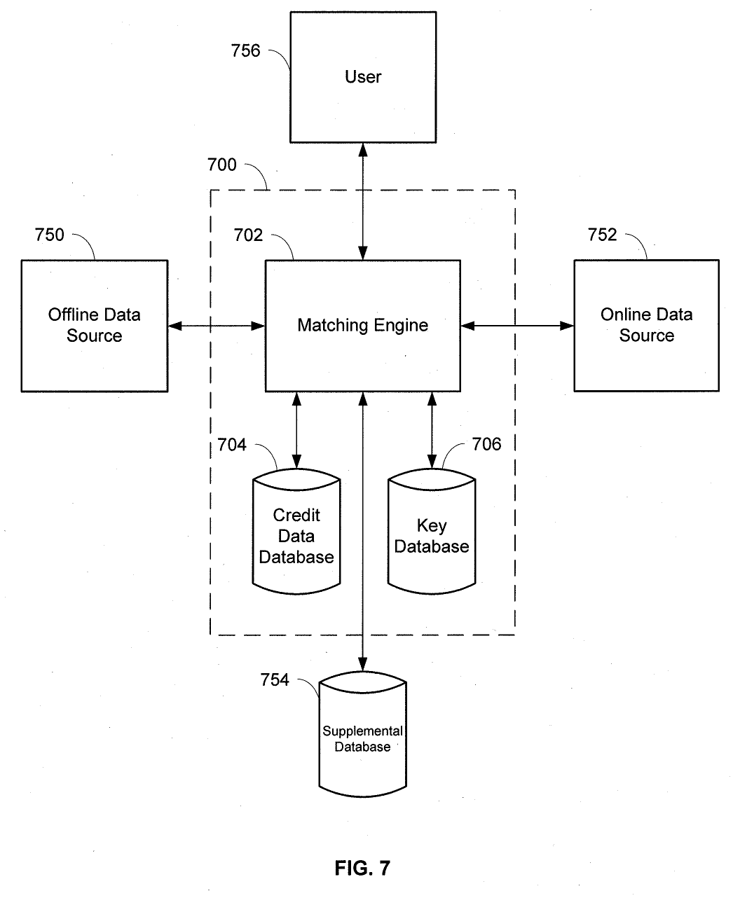

FIG. 7 illustrates a matching system 700 for comparing and matching offline data and online data with credit-related data to identify matching targeted individuals, in accordance with one or more principles of the invention. The system 700 may utilize offline data received from an offline data source 750 and online data received from an online data source 752. The system 700 may also communicate with a user 756, such as buyers of advertising space, advertising businesses, and other advertisers, for receiving information or requests, or transmitting keys or other results, in some embodiments. The user 756 may also transmit a user input file that includes names and addresses of targeted individuals, for example, as offline data to the system 700, in some embodiments. Users may directly or indirectly purchase or otherwise obtain the advertising space from distributors, such as advertising networks and publishers, to distribute advertisements to the targeted individuals using data gleaned from the online activity of the targeted individuals. Targeted individuals may be, for example, consumers and/or persons employed, affiliated, and/or associated with a business, such as owners, executives, and/or employees of the business. Distributors may own the advertising space and/or represent another entity which owns the advertising space. Various components of the system 700 may be implemented using software executable by one or more servers or computers, such as a computing device 600 with a processor 602 and memory 604 as shown in FIG. 6, which is described above.

The matching system 700 may include a matching engine 702 for receiving, comparing, and matching the offline data and online data with credit-related data to identify matching targeted individuals. The matching engine 702 may be in communication with the offline data source 750, the online data source 752, and/or the user 756 through a data network, such as the Internet. The matching engine 702 may also be in communication with a database, such as a credit data database 704, which includes the credit-related data, such as credit header data; a key database 706 for storing keys for linking offline data and online data; and/or a supplemental database 754 including supplemental information. In some embodiments, the credit data database 704 and the key database 706 may be included in the matching system 700 and the supplemental database 754 may be external to the matching system 700. In other embodiments, none, some, or all of the databases 704, 706 and 754 may be included in the matching system 700 or may be external to the matching system 700.

Offline data can be received from the offline data source 750 by the matching engine 702. The offline data may include data that is associated with non-Internet or non-online activity and that is separate from online data. For example and without limitation, offline data can be consumer- or business-related data, consumer identifying data, aggregated credit data, credit scores, pre-screen offers, business identifiers, product profits, estimated incomes, actual incomes, consumer behavioral data, wealth data, education data, vehicle ownership data, proprietary data, non-aggregated credit data, public records, and/or similar data. The offline data source 750 may include, for example, public records sources (e.g., business registration records, property records, etc.), customer records sources (e.g., registration information, etc.), credit records sources, and the like. The offline data may also include a user input file. The offline data can include one or more offline data records. In some embodiments, the offline data may include data at the level of the targeted individual, e.g., consumer-level data, and/or aggregated data applied to a targeted individual, e.g., census summary data for a particular targeted individual. In an embodiment, the offline data is depersonalized so that the identity of targeted individuals is not known.

Online data can be received from the online data source 752 by the matching engine 702. The online data may include data associated with Internet or online activity, such as, for example and without limitation, data associated with web browsing, click-through data, click stream data, cookies, e-mail account information, online registration data, online transaction data, online site usage data, IP addresses, electronic device identifiers, phone numbers, search result data, biometric data, network identifiers, Media Access Control addresses, and/or other similar data. The online data source 752 may include, for example, websites, e-mail providers, e-commerce entities, publishers, distributors, data partners, and the like. The online data can include one or more online data records. In an embodiment, the online data is depersonalized so that the identity of targeted individuals is not known.

The matching engine 702 may access the credit data database 704 and retrieve credit-related data. The credit-related data may include credit header data, such as identifying information for a plurality of targeted individuals, such as names, dates of birth, identification numbers (e.g., social security numbers, national identification numbers, etc.), street addresses, cities, states, zip codes, telephone numbers, account numbers (e.g., credit card account numbers, loan account numbers, etc.), and/or other identifying information. In some embodiments, the credit-related data may include historical data for the identifying information, such as previous addresses, telephone numbers, names, etc. for the targeted individuals. The credit-related data in the credit data database 704 may be maintained by a credit bureau, for example. In some embodiments, the credit-related data in the credit data database 704 may include data sourced or originated from a credit bureau, a credit reporting company, and/or another entity.

The matching engine 702 may compare the credit-related data with the offline data records, and compare the credit-related data with the online data records. The offline data and the online data may be compared to the credit-related data in order to determine whether a particular offline data record and/or particular online data records corresponds to a particular matching targeted individual. In particular, the offline data records may be matched to the identifying information in the credit-related data for the particular matching targeted individual, and the online data records may be matched to the identifying information in the credit-related data for the particular matching targeted individual. If an offline data record matches the identifying information for a matching targeted individual, then the matching engine 702 can designate that the offline data record corresponds to the matching targeted individual. Similarly, if an online data record matches the identifying information for a matching targeted individual, then the matching engine 702 can designate that the online data record corresponds to the matching targeted individual. In this way, the offline data record and the online data record can be independently compared to the credit-related data to ensure that accuracy and completeness of the matching. In other words, a matching targeted individual can be determined by separately comparing offline data to the credit-related data, and online data to the credit-related data.

In some embodiments, the matching engine 702 can compare the offline data records and/or the online data records to supplemental data and/or the credit-related data. The matching engine 702 may access a supplemental database 754 to retrieve the supplemental data. This may be the case, for example, when a particular offline data record or online data record by itself is insufficient to match a particular targeted individual. In this case, the data record may need to be cross-referenced with supplemental data to achieve a successful match with identifying information in the credit-related data for a particular targeted individual. In an embodiment, the supplemental data may be appended to an offline data record and/or an online data record to improve the matching performed by the matching engine 702. Accordingly, if the supplemental data and/or the identifying information for a matching targeted individual matches a particular offline or online data record, the matching engine 702 can designate that the data record corresponds to the matching targeted individual.

If both an offline data record corresponds to a matching targeted individual and an online data record corresponds to the matching targeted individual, then the matching engine 702 can generate a key to link the offline data record and the online data record. The key may be stored by the matching engine 702 in a key database 706. The key may be alphabetic, numeric, alphanumeric, and/or in another format. In one embodiment, the key includes one or more identifiers or references to the offline data record and/or the online data records that correspond to the matching targeted individual. In another embodiment, the key includes the offline data record and the online data record corresponding to the matching targeted individual. In a further embodiment, the key includes the offline data record corresponding to the matching targeted individual and a link or reference to the online data record corresponding to the matching targeted individual. In another embodiment, the key includes the online data record corresponding to the matching targeted individual and a link or reference to the offline data record corresponding to the matching targeted individual. Keys may also be transmitted from the matching engine 702 to the user 756 or another entity. The user 756 may utilize the keys to target advertisements, push notifications, and the like to the particular matching targeted individuals. In particular, the keys may assist the user 756 in knowing that a particular online user is the matching targeted individual, based on the offline data and the online data.

As an example, the offline data may include information from product warranty cards, such as the names, addresses, phone numbers, and email addresses for a particular set of targeted individuals. The online data may include the registration and transaction information for a retail e-commerce website that includes the names, addresses, and purchase history for another set of targeted individuals. The matching engine 702 may receive these offline data records and online data records, and then access the credit data database 704 to retrieve credit-related data. The matching engine 702 may compare identifying information from the credit-related data to the offline data, and separately compare identifying information from the credit-related data to the online data. If a particular offline data record and a particular online data record both match the same matching targeted individual, based on the comparisons with the credit-related data, the matching engine 702 may designate that the particular offline data record and the particular online data record correspond to that matching targeted individual. The matching engine 702 may generate a key that links the particular offline data record and the particular online data record for that matching targeted individual. The key may be stored by the matching engine 702 in a key database 706.

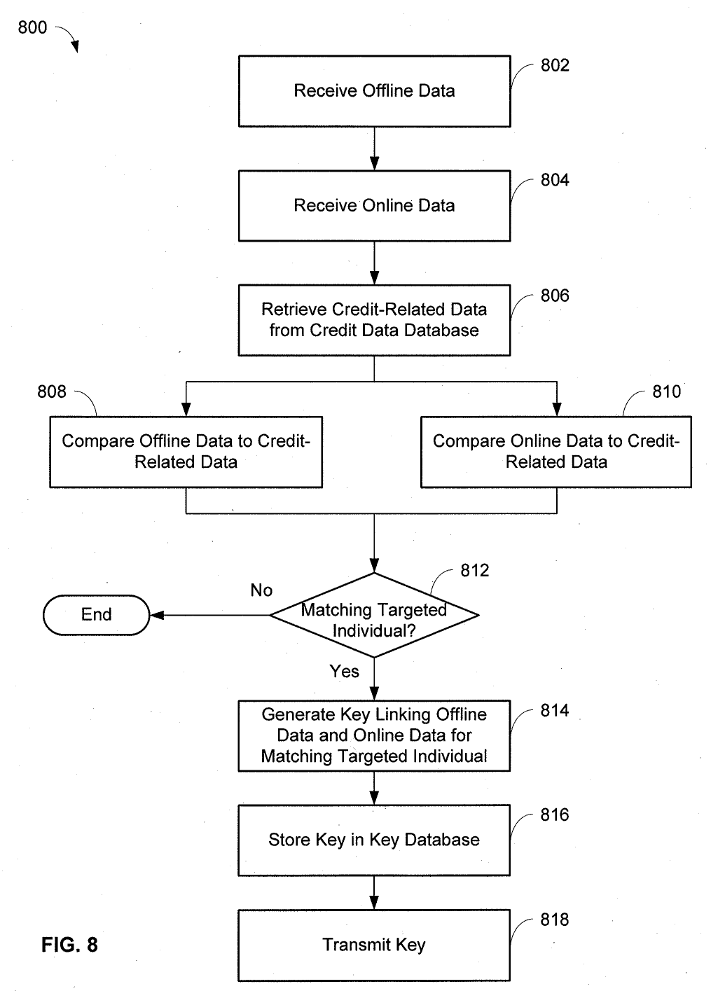

An embodiment of a process 800 for comparing and matching offline data and online data with credit-related data to identify matching targeted individuals is shown in FIG. 8, in accordance with one or more principles of the invention. The process 800 may result in the generation, storage, and transmission of a key linking offline data and online data to a matching targeted individual. The matching engine 702 may perform all or part of the process 800, and the process 800 can utilize the credit data database 704, the key database 706, and/or the supplemental database 754.

At step 802, offline data may be received from an offline data source 750. The offline data may include data that is associated with non-Internet or non-online activity and that is separate from online data. For example, offline data can be consumer- or business-related data, consumer identifying data, aggregated credit data, credit scores, pre-screen offers, business identifiers, product profits, estimated incomes, actual incomes, consumer behavioral data, wealth data, education data, vehicle ownership data, proprietary data, non-aggregated credit data, public records, and/or similar data. Online data may be received at step 804 from an online data source 752. The online data may include data associated with Internet or online activity, such as data associated with web browsing, click-through data, click stream data, cookies, e-mail account information, online registration data, online transaction data, online site usage data, IP addresses, electronic device identifiers, phone numbers, search result data, biometric data, network identifiers, Media Access Control addresses, and/or other similar data.

Credit-related data may be retrieved at step 806 from a database, such as a credit data database 704. The credit-related data may include identifying information for a plurality of targeted individuals, such as names, dates of birth, identification numbers, street addresses, cities, states, zip codes, telephone numbers, account numbers, and/or other identifying information. In some embodiments, the credit-related data may include historical data for the identifying information, such as previous addresses, telephone numbers, names, etc. for the targeted individuals.

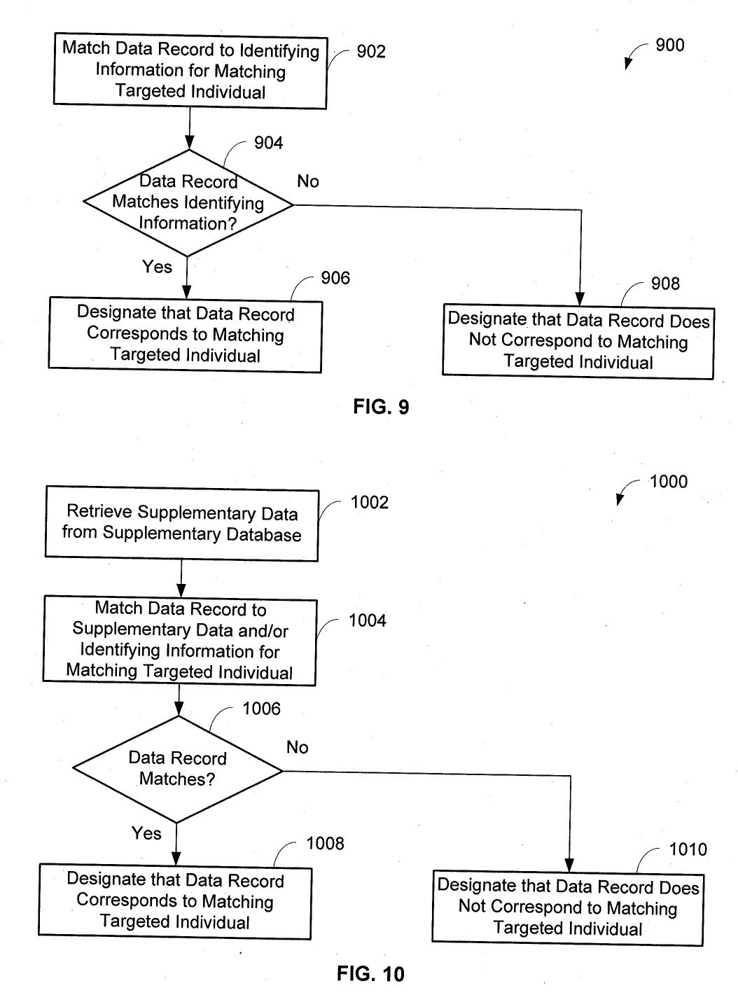

At step 808, the offline data records in the offline data may be compared to the credit-related data. The online data records in the online data may be compared to the credit-related data at step 810. The offline data and the online data may be compared at steps 808 and 810 to the credit-related data in order to determine whether a particular offline data record and/or particular online data records corresponds to a particular matching targeted individual. In some embodiments, the offline data records and/or the online data records may be compared at steps 808 and 810, respectively, with the credit-related data and with non-credit-related data. Further details regarding steps 808 and 810 are described below with reference to FIGS. 9 and 10.

It may be determined at step 812 whether an offline data record corresponds to a matching targeted individual and an online data record corresponds to the same matching targeted individual. If the offline data record does not correspond to a matching targeted individual and/or an online data record does not correspond to the same matching targeted individual at step 812, then the process 800 may be complete. However, if both the offline data record corresponds to a matching targeted individual and an online data record corresponds to the same matching targeted individual at step 812, then the process 800 continues to step 814. At step 814, a key may be generated to link the offline data record and the online data record for the matching targeted individual. The key may be stored at step 816 in a key database 706. The key may also be transmitted at step 818, such as to a user or another entity. The user or other entity may utilize the key to target advertisements, push notifications, and the like to the particular matching targeted individuals.

An embodiment of a process 900 for comparing data to credit-related data is shown in FIG. 9, in accordance with one or more principles of the invention. The process 900 may correspond to step 808 for comparing offline data and/or step 810 for comparing online data of the process 800 described above. At step 902, an offline data record or an online data record may be matched to the identifying information in the credit-related header for a particular matching targeted individual. It may be determined at step 904 whether the offline data record or the online data record matches the identifying information. If the offline data record or online data record matches the identifying information at step 904, then the process 900 continues to step 906 to designate that the offline data record or online data record corresponds to the matching targeted individual. However, if the offline data record or online data record does not match the identifying information at step 904, then the process 900 continues to step 908 to designate that the offline data record or online data record does not correspond to the matching targeted individual.

An embodiment of a process 1000 for comparing data to credit-related data is shown in FIG. 10, in accordance with one or more principles of the invention. The process 1000 may correspond to step 808 for comparing offline data and/or step 810 for comparing online data of the process 800 described above. At step 1002, supplementary data may be retrieved from a supplementary database. At step 1004, an offline data record or an online data record may be matched to the supplementary data and/or the identifying information in the credit-related header for a particular matching targeted individual. It may be determined at step 1006 whether the offline data record or the online data record matches the supplementary data and/or the identifying information. If the offline data record or online data record matches the supplementary data and/or the identifying information at step 1006, then the process 1000 continues to step 1008 to designate that the offline data record or online data record corresponds to the matching targeted individual. However, if the offline data record or online data record does not match the identifying information at step 1006, then the process 1000 continues to step 1010 to designate that the offline data record or online data record does not correspond to the matching targeted individual.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

What is claimed:

1. A method for matching of offline data and online data, using a processor, the method comprising:
receiving the offline data at the processor, the offline data comprising at least one offline data record;
receiving the online data at the processor, the online data comprising at least one online data record;
retrieving credit-related data from a database using the processor, the credit-related data comprising identifying information for a plurality of targeted individuals;
comparing the at least one offline data record to the credit-related data, using the processor, to determine whether the at least one offline data record corresponds to a matching targeted individual of the plurality of targeted individuals;
comparing the at least one online data record to the credit-related data, using the processor, to determine whether the at least one online data record corresponds to the matching targeted individual;
if the at least one offline data record corresponds to the matching targeted individual and the at least one online data record corresponds to the matching targeted individual:
generating a key linking the at least one offline data record and the at least one online data record, using the processor; and
storing the key in a key database, using the processor.

2. The method of claim 1, wherein:
the identifying information for the plurality of targeted individuals comprises first identifying information for the matching targeted individual; and
comparing the at least one offline data record comprises:
matching the at least one offline data record to the first identifying information for the matching targeted individual, using the processor; and
designating that the at least one offline data record corresponds to the matching targeted individual, using the processor, if the at least one offline data record matches the first identifying information for the matching targeted individual.

3. The method of claim 1, wherein:
the identifying information for the plurality of targeted individuals comprises second identifying information for the matching targeted individual;
comparing the at least one online data record comprises:
matching the at least one online data record to the second identifying information for the matching targeted individual, using the processor; and
designating that the at least one online data record corresponds to the matching targeted individual, using the processor, if the at least one online data record matches the second identifying information for the matching targeted individual.

4. The method of claim 1, wherein the offline data is associated with non-Internet activity and comprises one or more of aggregated credit data, consumer identifying data, a credit score, a pre-screen offer, a business identifier, a product profit, an estimated income, an actual income, consumer behavioral data, wealth data, education data, vehicle ownership data, proprietary data, non-aggregated credit data, or a public record.

5. The method of claim 1, wherein the online data is associated with Internet activity and comprises one or more of a cookie, click-through data, click stream data, e-mail account information, online registration data, online transaction data, online site usage data, an IP address, an electronic device identifier, search result data, biometric data, a network identifier, or a Media Access Control address.

6. The method of claim 1, wherein the identifying information for the plurality of targeted individuals comprises one or more of a name, a date of birth, an identification number, a street address, a city, a state, a zip code, a telephone number, or an account number.

7. The method of claim 1, wherein the identifying information for the plurality of targeted individuals comprises one or more of a name history, a street address history, a city history, a state history, a zip code history, a telephone number history, or an account number history.

8. The method of claim 1, wherein comparing the at least one online data record comprises:
retrieving supplemental data from a supplemental database, using the processor; and
comparing the at least one online data record to one or more of the supplemental data or the credit-related data, using the processor, to determine whether the at least one online data record corresponds to the matching targeted individual.

9. The method of claim 8, wherein:
the identifying information for the plurality of targeted individuals comprises third identifying information for the matching targeted individual; and
comparing the at least one online data record to one or more of the supplemental data or the credit-related data comprises:
matching the at least one online data record to one or more of the supplemental data or the third identifying information for the matching targeted individual, using the processor; and
designating that the at least one online data record corresponds to the matching targeted individual, using the processor, if the at least one online data record matches one or more of the supplemental data or the third identifying information for the matching targeted individual.

10. The method of claim 1, further comprising transmitting the key from the processor, if the at least one offline data record corresponds to the matching targeted individual and the at least one online data record corresponds to the matching targeted individual.

11. The method of claim 1, wherein the credit-related data comprises credit header data.

12. A system for matching of offline data and online data, the system comprising:
a processor in communication with a network;
a memory in communication with the processor, the memory for storing:
a database comprising credit-related data;
a key database for storing a key;
a matching engine for:
receiving the offline data, the offline data comprising at least one offline data record;
receiving the online data, the online data comprising at least one online data record;
retrieving credit-related data from the database, the credit-related data comprising identifying information for a plurality of targeted individuals;
comparing the at least one offline data record to the credit-related data to determine whether the at least one offline data record corresponds to a matching targeted individual of the plurality of targeted individuals;
comparing the at least one online data record to the credit-related data to determine whether the at least one online data record corresponds to the matching targeted individual;
if the at least one offline data record corresponds to the matching targeted individual and the at least one online data record corresponds to the matching targeted individual:
generating the key linking the at least one offline data record and the at least one online data record; and
storing the key in the key database.

13. The system of claim 12, wherein:
the identifying information for the plurality of targeted individuals comprises first identifying information for the matching targeted individual; and
the matching engine compares the at least one offline data record by:
matching the at least one offline data record to the first identifying information for the matching targeted individual; and
designating that the at least one offline data record corresponds to the matching targeted individual, if the at least one offline data record matches the first identifying information for the matching targeted individual.

14. The system of claim 12, wherein:
the identifying information for the plurality of targeted individuals comprises second identifying information for the matching targeted individual;
the matching engine compares the at least one online data record by:
matching the at least one online data record to the second identifying information for the matching targeted individual; and
designating that the at least one online data record corresponds to the matching targeted individual, if the at least one online data record matches the second identifying information for the matching targeted individual.

15. The system of claim 12, wherein the offline data is associated with non-Internet activity and comprises one or more of aggregated credit data, consumer identifying data, a credit score, a pre-screen offer, a business identifier, a product profit, an estimated income, an actual income, consumer behavioral data, wealth data, education data, vehicle ownership data, proprietary data, non-aggregated credit data, or a public record.

16. The system of claim 12, wherein the online data is associated with Internet activity and comprises one or more of a cookie, click-through data, click stream data, e-mail account information, online registration data, online transaction data, online site usage data, an IP address, an electronic device identifier, search result data, biometric data, a network identifier, or a Media Access Control address.

17. The system of claim 12, wherein the identifying information for the plurality of targeted individuals comprises one or more of a name, a date of birth, an identification number, a street address, a city, a state, a zip code, a telephone number, or an account number.

18. The system of claim 12, wherein the identifying information for the plurality of targeted individuals comprises one or more of a name history, a street address history, a city history, a state history, a zip code history, a telephone number history, or an account number history.

19. The system of claim 12, wherein the matching engine compares the at least one online data record by:
retrieving supplemental data from a supplemental database; and
comparing the at least one online data record to one or more of the supplemental data or the credit-related data to determine whether the at least one online data record corresponds to the matching targeted individual.

20. The system of claim 19, wherein:
the identifying information for the plurality of targeted individuals comprises third identifying information for the matching targeted individual; and
the matching engine compares the at least one online data record to one or more of the supplemental data or the credit-related data by:
matching the at least one online data record to one or more of the supplemental data or the third identifying information for the matching targeted individual; and
designating that the at least one online data record corresponds to the matching targeted individual if the at least one online data record matches one or more of the supplemental data or the third identifying information for the matching targeted individual.

21. The system of claim 12, wherein the matching engine is further for transmitting the key, if the at least one offline data record corresponds to the matching targeted individual and the at least one online data record corresponds to the matching targeted individual.

22. The system of claim 12, wherein the credit-related data comprises credit header data.
